(19) United States
(12) Patent Application Publication
(10) Pub. No.: US 2013/0246939 A9
(43) Pub. Date: Sep. 19, 2013

(54) Calendar Application for Communication Devices

(71) Applicants: William Tärneberg, Lund (SE); Mikael Hellberg, Lomma (SE)

(72) Inventors: William Tärneberg, Lund (SE); Mikael Hellberg, Lomma (SE)

(73) Assignee: Sony Ericsson Mobile Communications AB, Lund (SE)

(21) Appl. No.: 13/215,265

(22) Filed: Aug. 23, 2011

Related U.S. Application Data
(63) Continuation of application No. PCT/IB2010/055890, filed on Dec. 16, 2010.

(51) Int. Cl. G06F 3/048; G06F 15/16

(52) U.S. Cl. 715/753

(57) ABSTRACT

An electronic device has a touch-sensitive display and a controller that executes an application. The application bisects a display into a plurality of regions using a timeline. In a first region on a first side of the timeline, the application displays events that are originated by the user of the device. In a second region on a second, opposite side of the timeline, the application displays events that are associated with the user, but are originated by others. Activities associated with the user are displayed along the timeline. The events and activities on the timeline can be shared with other users using drag-n-drop operations.

### RELATED APPLICATION

This application claims the benefit of priority from Application Serial No. PCT/IB2010/055890. The '890 application, which is entitled “A Calendar Application for Communication Devices,” was filed Dec. 16, 2010 and is incorporated herein by reference in its entirety.

### FIELD OF THE INVENTION

The present invention relates generally to wireless communication devices, and more particularly to wireless communication devices configured to execute calendar applications.

### BACKGROUND

There are many different calendar software applications currently available. Most run on Personal Computers (PCs) or similar computing device, although many also run on handheld wireless devices such as cellular telephones, Personal Digital Assistants (PDAs), and tablet computing devices. No matter the platform, however, most, if not all calendar software applications, share a common basic characteristic. Specifically, conventional calendar software applications generally allow users to view and/or interact with upcoming appointments and events. For the most part, they do not provide ways for users to interact with appointments and events that have already occurred in an elegant manner or in a way that compels user interaction. Nor do they provide a view of the actual outcomes of appointments, or how they are related in time to each other and to other events.

Additionally, conventional software applications do not currently present all of the events and appointments that effect a user, past or future, on a display for the user to read easily. For example, they do not generate or chronologically indicate combined events for messages or phone calls originated by, or received by, the user. Therefore, especially given the current lack of visual indications of chronological relationships between events and appointments, conventional calendar software applications do not meet all of the current needs of their intended users.

### SUMMARY

The present invention provides a system and method for collecting, organizing, and displaying a user's scheduling information in chronological order. Particularly, the present invention comprises a computer program that executes on a central processing unit (CPU) or other similar controller. When executed, the program configures the CPU to display a Graphical User Interface (GUI) that visually provides the user's scheduling information to indicate to the user which events and/or activities have already occurred, and which have yet to occur. The program will cause the CPU to organize and display events as being user-originated, or not user originated (i.e., originated by some other party). Further, the program allows the user to easily manipulate the information associated with the events and/or activities, and to share events and/or activities with other users.

Accordingly, in one embodiment, the present invention provides a method for aggregating and displaying scheduling information on a communication device. The method comprises bisecting a display screen of a communication device using a timeline, displaying events originated by a user of the communication device on a first side of the timeline, displaying events associated with the user but originated by a remote party on a second side of the timeline opposite the first side, displaying activities associated with the user along the timeline, and displaying a current timeline indicator on the display screen to indicate which of the events and activities has already occurred, and which of the events and activities have yet to occur.

In one embodiment, the method further comprises establishing a communication link between the user's communications device and a remote communications device associated with a remote user, receiving a timeline associated with the remote party via the communication link, and displaying the remote party's timeline on the display screen of the user's communications device.

In one embodiment, the method further comprises subscribing to receive one or more timelines associated with each of one or more corresponding other parties, indicating each of the timelines associated with one or more other parties on the display screen, and selecting the remote party's timeline from among the plurality of timelines on the display screen.

In one embodiment, the method further comprises adding one or more activities displayed along the remote party's timeline to the user's timeline responsive to the user dragging and dropping the one or more activities from the remote party's timeline onto the user's timeline.

In one embodiment, the method further comprises adding one or more activities displayed along the user's timeline to the remote party's timeline responsive to the user dragging and dropping the one or more activities from the user's timeline onto the remote party's timeline.

In one embodiment, the method further comprises controlling the display screen of the user's computer device to fade the events on the first and second sides of the timeline from the display screen responsive to receiving the remote party's timeline.

In one embodiment, displaying a current timeline indicator on the display screen comprises displaying the current timeline indicator to intersect the timeline at a current time.

In one embodiment, the method further comprises adding a new event to the first side of the timeline responsive to the user selecting a past event, wherein the new event and the past event are of the same event type.

In one embodiment, the method further comprises adding a new event to the second side of the timeline responsive to the remote party initiating the event.

In one embodiment, the method further comprises adding a new activity along the user's timeline responsive to the user contacting the display screen along the timeline.

The present invention also provides a communications device configured to perform embodiments of the present invention. In one embodiment, the communication device comprises a display, memory configured to store scheduling information associated with the user, and a controller. The controller is configured to bisect the display using a timeline, display events originated by a user of the communication device on a first side of the timeline, display events associated with the user but originated by a remote party on a second side of the timeline opposite the first side, display activities associated with the user along the timeline, and display a current timeline indicator on the display to indicate which of the events and activities has already occurred, and which of the events and activities have yet to occur.

In one embodiment, the device further comprises a communications interface configured to establish a communication link with a remote communications device associated with a remote user, receive a timeline from the remote party via the communication link, and display the remote party's timeline on the display of the user's communications device.

In one embodiment, the controller is further configured to subscribe to receive one or more timelines associated with each of one or more other parties, indicate each of the timelines associated with one or more other parties on the display, and select the remote party's timeline from among the plurality of timelines on the display responsive to user input.

In one embodiment, the controller is further configured to detect a drag and drop operation in which the user drags one or more selected activities from the remote party's timeline and drops the one or more selected activities along the user's timeline, and add the one or more selected activities to the user's timeline responsive to the drag and drop operation.

In one embodiment, the controller is further configured to detect a drag and drop operation in which the user drags one or more selected activities from the user's timeline and drops the one or more selected activities along the remote party's timeline, and add the one or more selected activities to the remote party's timeline responsive to the drag and drop operation.

In one embodiment, the controller is further configured to fade the events on the first and second sides of the timeline from the display responsive to receiving the remote party's timeline.

In one embodiment, the controller is further configured to display the current timeline indicator to intersect the timeline at a current time.

In one embodiment, the controller is further configured to add a new event to the first side of the timeline responsive to the user selecting a past event, wherein the new event and the past event are of the same event type.

In one embodiment, the controller is further configured to add a new event to the second side of the timeline responsive to the remote party initiating the event.

In one embodiment, the controller is further configured to add a new activity along the user's timeline responsive to the user contacting the display screen along the timeline.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 is a block diagram of an electronic device suitable to be configured to operate according to one embodiment of the present invention.

FIG. 2 is a perspective view illustrating a cellular wireless communication device configured according to one embodiment of the present invention.

FIG. 3 is a perspective view of a Graphical User Interface (GUI) on a touch-sensitive display configured according to one embodiment of the present invention.

FIG. 4 is a perspective view of the GUI configured according to another embodiment of the present invention.

FIG. 5 is a flow diagram illustrating a method for displaying scheduling information according to one embodiment of the present invention.

FIG. 6 is a flow diagram illustrating a method for adding and/or updating scheduling information according to one embodiment of the present invention.

FIG. 7 illustrates perspective views of other types of computing devices suitable for use with the present invention.

### DETAILED DESCRIPTION

The present invention provides a communications device configured to collect, organize, and display a user's scheduling information on a touch-sensitive interface of the device. Particularly, the present invention comprises an application that executes on the communications device. The application configures the device to collect information regarding events and activities that are associated with the user. The events and activities may be originated by the user, or may be originated by a remote party. The application also configures the device to display the events and activities chronologically along a timeline at the time they occurred. This enables a user to view and interact with past events and activities (i.e., those that have already occurred), as well as those that are currently occurring, and those that have yet to occur (i.e., future events and activities). The application also provides users with the ability to add and/or update their own timelines using information from the timelines of one or more other users.

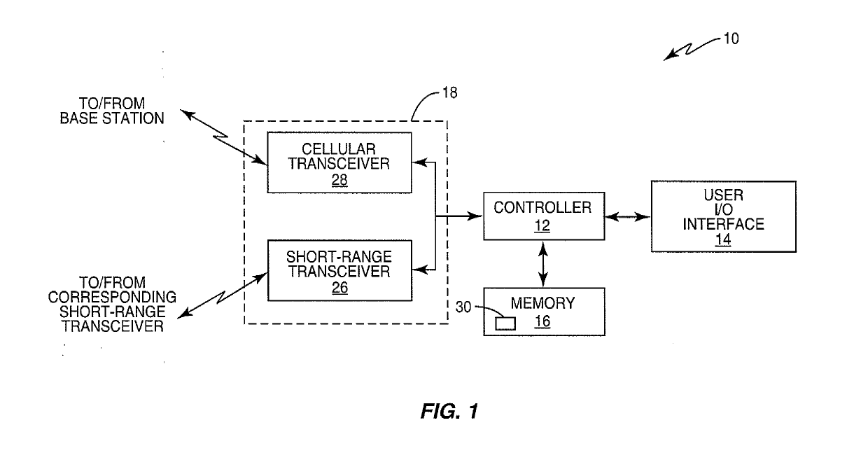

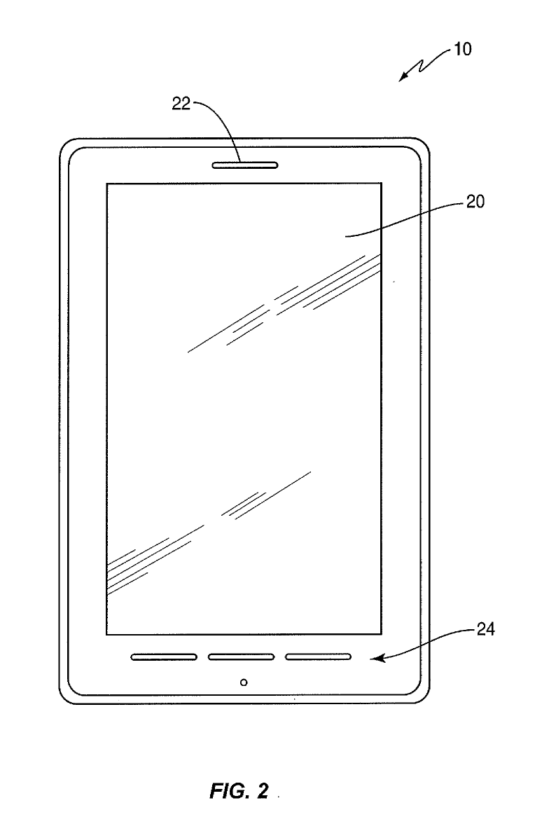

Turning now to the drawings, FIGS. 1 and 2 illustrate some of the components (FIG. 1) of a communications device configured to operate according to the present invention. As described herein, one type of communications device suitable for configuring according to the present invention comprises a cellular telephone 10 (see FIG. 2). However, as seen in later figures, the present invention is not limited to operation only on cellular telephones 10, but instead, may be executed on other communications devices as well.

Cellular telephone 10 comprises a programmable controller 12, a user input/output interface 14, a memory 16, and a communications interface 18. The controller 12 may, for example, be implemented as a single microprocessor or multiple microprocessors. Suitable microprocessors may include, but are not limited to, general purpose and special purpose microprocessors as well as digital signal processors and/or image processors. The controller 12 controls the operation of the cellular telephone 10 according to one or more programs and data stored in memory 16. As is known in the art, such programs and data control the cellular telephone's 10 ability to perform functions such as establish a communications link with a remote party, and to transmit/receive data with the remote party. However, as described later in more detail, the cellular telephone 10 includes an application program 30 that contains the logic and instructions for controlling the cellular telephone 10 to collect, organize, and display events and activities that are associated with a user in chronological order.

The User I/O Interface (UI) 14 generally includes one or more components that permit the user to interact with, and control the operation of, the cellular telephone 10. As best seen in FIG. 2, this generally includes components such as a speaker 22 and one or more user controls 24. The user controls 24, which may comprise a variety of knobs, switches, keys, button controls, or dials, for example, are distributed across the housing of the digital camera device 10.

In this embodiment, the UI 16 also includes a touch-sensitive display 20. According the present invention, the application program 30, when executed by controller 12, provides a Graphical User Interface (GUI) on touch-sensitive display 20. The GUI permits the user to intuitively interact with applications executing on the cellular telephone 10 using touch. More particularly, the GUI on display 20 displays a chronological ordering of the user's scheduling information to the user, and handles user touches, which are detected by the touch-sensitive display 20, to allow the user to interact with the present invention.

Memory 16 is a computer readable medium representing the entire hierarchy of memory in cellular telephone 10, and may comprise both random access memory (RAM) and read-only memory (ROM). As previously stated, the computer program instructions and data required for operation of the cellular telephone 10 (e.g., application 30) are stored in non-volatile memory, such as EPROM, EEPROM, and/or flash memory. Memory 16 may be implemented, for example, as one or more discrete devices, stacked devices, or removable devices, such as a flash drive or memory stick, or may be integrated with controller 12.

The communications interface 18 permits the user of cellular telephone 10 to communicate and exchange data with one or more remote parties. As seen in FIG. 1, the communications interface 18 may comprise, for example, a short-range transceiver 26 and/or a cellular transceiver 28. The cellular transceiver 28 is a fully functional cellular radio transceiver, and operates according to any known standard, including Global System for Mobile Communications (GSM), TINEIA-136, cdmaOne, cdma2000, UMTS, and Wideband CDMA. According to the present invention, cellular transceiver 28 is configured to receive signals from, and transmit signals to, one or more remote parties via one or more base stations subsystems in a wireless communication network (not shown). The short-range transceiver 26 is configured to transmit signals to and receive signals via a short-range interface from a remote party having a corresponding short-range transceiver. In one embodiment, short-range transceiver 26 comprises a BLUETOOTH transceiver or RF transceiver operating according to the IEEE 802.11 family of standards.

The standards and protocols used by the cellular transceiver 28 and short-range transceiver 26 to communicate data are well-known to those of ordinary skill in the art. Therefore, the details about the standards and protocols are not explicitly provided herein. It is sufficient to say that, according to one embodiment of the present invention, both transceivers 26, 28 are configured to share the scheduling information and data associated with a given timeline with one or more other devices) in accordance with their respective protocols and standards.

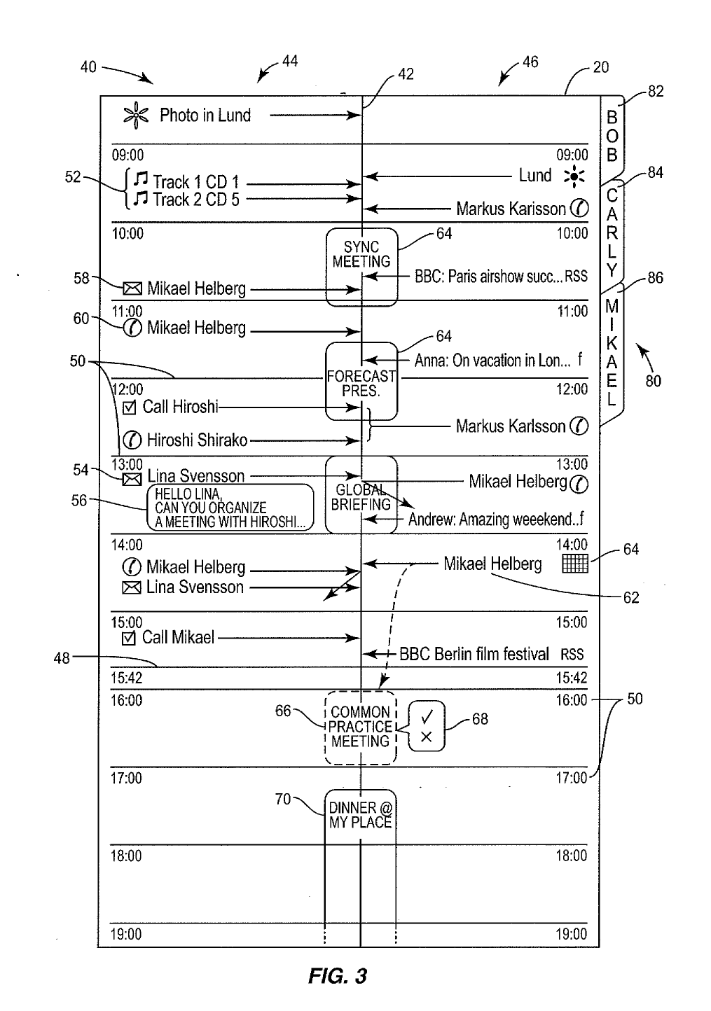

As seen in FIG. 3, the application 30, when executed by the controller 12, displays a GUI 40 on the touch-sensitive display 20 that allows the user of cellular telephone 10 to interact with the present invention. The GUI 40 comprises a timeline 42 that bisects the display 20 into two different, but substantially equally-sized, regions. Particularly, the timeline 42 extends longitudinally to partition the display 20 into a first region 44 that lies on a first side of the timeline, and a second region 46 that lies on the second, opposing side of the timeline 42. Additionally, a current time indicator 48 and a plurality of horizontal lines 50 extends across display 20.

The current time indicator 48 extends horizontally across display 20 and intersects the timeline 42 at substantially a right angle. According to the present invention, the current time indicator 48 progresses vertically relative to the timeline 42 to mark the current time of day. As seen in FIG. 3, the current time may be shown on each side of the current time indicator 48. All past events and activities, which are described later in more detail, appear “behind” the current time indicator 48 while future events and activities appear below the current time indicator 48. A current event or activity will appear at the intersection of the timeline 42 and the current time indicator 48. Similarly, the lines 50 are spaced vertically along the timeline 42. Each line 50 is labeled to indicate a time of day at equal intervals (e.g., every hour) thereby partitioning the display 20 into substantially equal portions.

In one embodiment, the background color of GUI 40 is based on the time of day. For example, for hours associated with “nighttime,” the GUI 40 may have a dark blue background on which to display the timeline 43 and events/activities, and a lighter color for “daytime” hours. In another embodiment, the horizontal lines 50 and the corresponding times change color. In one embodiment, the application 30 provides one or more differentiating horizontal lines intersecting the timeline 42 that explicitly identify a day or time-of-day boundary.

The user may employ predetermined actions to navigate the timeline 42 on GUI 40. For example, to scroll forwards and backwards in time through the timeline 42, the user could perform a swiping action with his or her finger. Swiping a finger in a first direction would “scroll” the timeline 42 back in time to display events and/or activities that occurred in the past. Swiping a finger in a second, opposite direction would “scroll” the timeline 42 forward in time to display events and/or activities that have yet to occur. Additionally, a user can invoke the “zoom” feature of the display 20 to zoom in and out of a desired portion of the display using a “pinch” gesture. It is also possible for the application 30 to detect other dual/multi-touch gestures and perform some corresponding function.

The application 30, when executed by controller 12, collects, organizes, and displays events and activities associated with the user along the timeline 42. Specifically, all events that are originated by the user of cellular telephone 10 are placed in the first region 44. All events that are originated by a remote party are placed in the second region 46. Activities, depicted in the boxes or “bubbles” of FIG. 3, are placed along the timeline 42. The events and activities are placed on the timeline 42 at the time they occur, or at the time they will occur.

Events, whether originated by the user or some other remote party, comprise actions performed by the user and/or the remote party (i.e., what a person has done or contributed to the user's timeline). Exemplary events include, but are not limited to, actions such as listening to audio/viewing video 52, sending/receiving emails or MMS messages 54, 58, sending receiving telephone calls 60, making/reading a blog entry, and sending/receiving invitations to participate in an activity. Each event listed in the first and second regions 44, 46 are identified using a descriptive graphical icon and/or corresponding text. For example, from FIG. 3, it can be seen from the events placed in the first region 42 that the user sent an email 58 to “Mikael Hellberg” shortly before 11:00, and then placed a telephone call 60 to the same person shortly after 11:00.

If desired, the user can access specific details about the events by “tapping” the event icon or performing some similar action. For example, as seen in FIG. 3, the user can “tap” the “envelope” icon to view the contents 56 of the message 54 sent to “Lina Svensson” shortly after 13:00. Additionally, the application 30 can also launch a corresponding application program (e.g., an email application or a Short Message Service (SMS) application) responsive to another user action (e.g., a “double-tap” on the icon). This will allow the user to edit and send a new message to the same or different person.

Events are added to the timeline 42 by the user or by other users as they occur. In one embodiment, for example, an event is added responsive to a remote party sending an invitation to the user to participate in an activity such as a meeting. The person making the request is identified by the text 62 and the type of activity is indicated by the icon 64. The activity (i.e., the meeting) is illustrated using bubble 66, which is placed along the timeline 42. The bubble 66 is sized to indicate the length of time needed for the activity. Thus, as seen in FIG. 3, the bubble 66 extends between the horizontal lines 50 for 1600 and 1700 indicating the start and end times, respectively, and that the meeting will last for one hour.

As seen in FIG. 3, the bubble 66 identifying the requested meeting activity is bordered by dashed lines. This indicates that the activity is pending acceptance by the user. The user has the option to either accept or refuse the invitation by tapping one of the “ACCEPT” (i.e., checkmark) or “REFUSE” (i.e., ‘X’) icons next to the bubble 66. Upon accepting the invitation to attend the meeting, the dashed border lines will be replaced by solid lines indicating that the user has committed to attending the meeting.

As previously described, the present invention displays activities, such as the meeting represented by bubble 66, along the length of the timeline 42. Where events identify actions performed by the user (i.e., seen in the first region 44), or by others (i.e., seen in the second region 46), activities identify events that the user might attend. Some illustrative examples of an activity include, but are not limited to, appointments, business meetings, doctor appointments, vacations, scheduled dinners, and concerts. In one embodiment, the bubble or other icon that represents a given activity extends along the timeline 42 between the start and end times of the activity. All activities will have a start time, but may not have an end time. Those activities that do not have an end time are displayed on the timeline 42 as “fading out” at one end. For example, the bubble 70 represents a dinner activity that the user will attend beginning shortly after 1700. The bottom end of the bubble 70 fades out, and thus, indicates that the user did not provide an end time for this activity.

The user may edit the details for a given activity by double-tapping the desired activity. In one embodiment, for example, the application 30 will display a dialog box prompting the user to enter or modify the details for the activity. Similarly, a user can add an activity by tapping on a vacant part of the timeline 42. As when editing an existing activity, the application 30 will display one or more dialogs to allow the user to enter the activity details.

Additionally, the present invention also allows a user to share activities with other parties over an established communications link. Particularly, a user of timeline 42 may subscribe to share timeline information with other parties. As seen in FIG. 3, the user of timeline 42 subscribes to Bob, Carly, and Mikael—each identified in a subscriber section 80 of GUI 40 comprising a tab 82, 84, 86. The application 30 may add and delete a given tab, for example, based on the presence of the associated party. The user of timeline 42 need only to touch a desired tab to share activities with the associated party.

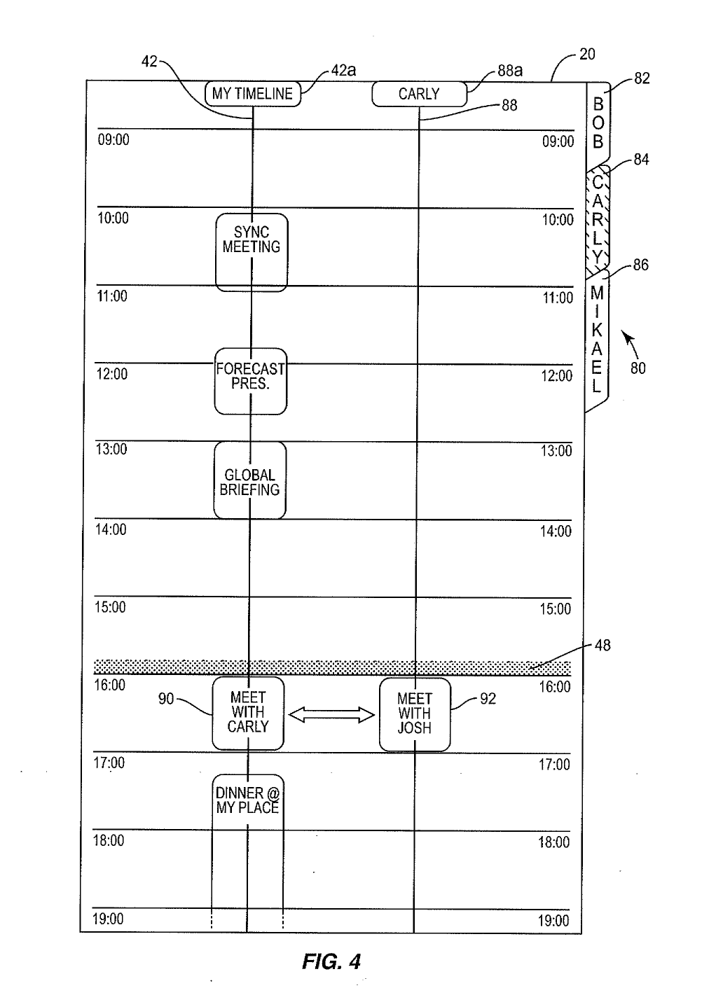

FIG. 4 illustrates how the GUI 40 may change when the user of timeline 42 selects tab 84. Particularly, the event information on both the first and second regions 44, 46 will fade away. The user's timeline 42, along with the user's activities, is also moved to one side of the display 20. This allows the application 30 to then display the selected party's timeline 88 along with their corresponding activities in the GUI 40. FIG. 4 illustrates only two timelines 42, 88 on GUI 40; however, those of ordinary skill in the art will readily appreciate that more than two timelines 42, 88 may be displayed on GUI 40 as needed or desired. To enable the user to identify which timeline 42 belongs to which party, the application 30 identifies the timelines using labels. In this case, the timelines for the user and the selected remote party are identified using labels 42a, 88a.

Information between parties is transferred via an established communications link. If a link is not established between the user and the remote party at the time the user selects the party, the application 30 will control the controller 12 and communications interface 18 to establish the link. As stated above, the user's cellular telephone 10 may comprise one or both of a cellular transceiver 28 and a short-range transceiver 26. Thus, the cellular telephone 10 may establish a cellular link or a short-range link with the selected party's device and transfer the information via that link.

To share activities between timelines 42, 88, the user need only to perform a “drag-n-drop” operation. Such operations, as opposed to manual data entry, enable the user to easily add or update activities from other timelines to other timelines (and vice versa). This allows a given user to better plan their lives. Specifically, the user could “drag” a selected activity from one timeline to another, and then “drop” the activity on the timeline. For example, FIG. 4 illustrates an activity 90 indicating the user's desire to meet with a friend, Carly, starting at 1600 and ending at 1700. Using a finger, for example, the user could drag the bubble representing the activity 90 from timeline 42 and drop it on timeline 88. Upon dropping the bubble, the application 30 could create a new activity 92 on timeline 88 sharing all the information related to that particular activity with the identified party (i.e., Carly) via the established communications link. A corresponding activity could appear on the device of the remote party along her timeline.

FIG. 4 describes this embodiment wherein the user performs a drag-n-drop operation to share a selected activity with a remote party such that the activity appears along the remote party's timeline 88. Nevertheless, it should be understood by those of ordinary skill in the art that the present invention also allows other parties to initiate establishing the communications link and share selected activities from between timelines.

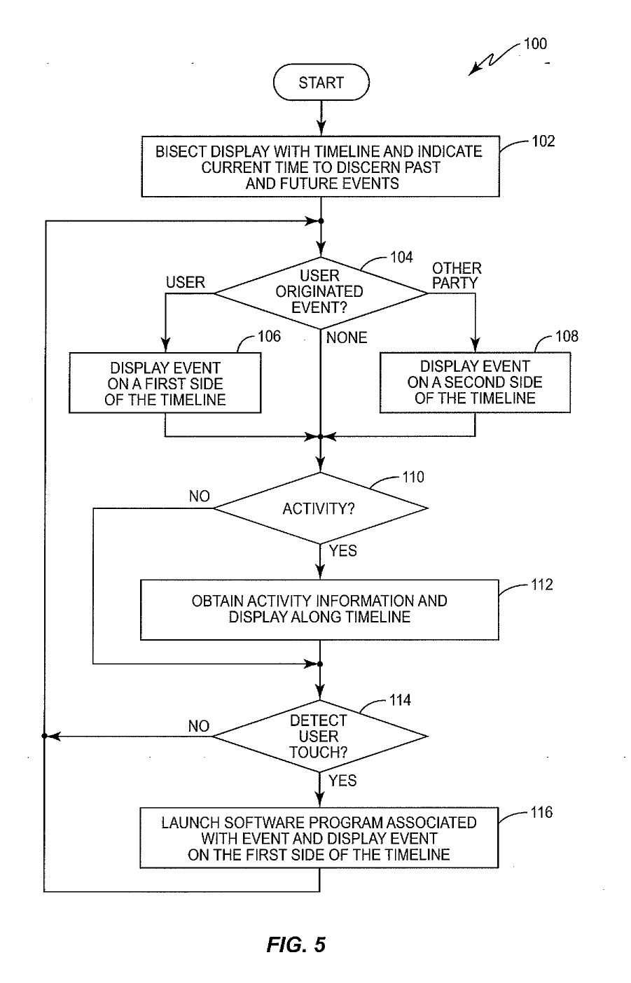

FIG. 5 is a flow diagram illustrating a method performed by application 30 according to one embodiment of the present invention. The method 100 begins when application 30, executed by controller 12, bisects the display 20 with the timeline 42 to form the first and second regions 44, 46, and indicates the current time using the current time indicator 48. The user can discern between past, current, and future events and activities using the current time indicator 48 (box 102). As events occur, the controller 12 determines whether the user originated the event or whether another party originated the event (box104). If the user originated the event, the controller 12 will, based on the instructions of application 30, display the event in the first region 44 on the first side of the timeline 42 (box 106). If the controller determines that a remote party originated the event, the controller 12 will display the event in the second region on the second side of the timeline 42, opposite the first side (box 108).

For activities, the controller will determine whether the user or another party added an activity (box 110). This determination maybe accomplished, for example, responsive to the user “dragging-and-dropping” an activity from someone else's timeline, or by manually adding the activity as previously described. Upon detecting the addition of an activity, the controller 12 will obtain the scheduling information about the activity and display a corresponding bubble or other indicator along the timeline 42 (box 112). Upon detecting a user touch on the display at an event or activity, for example, the controller 12 could launch a software program associated with the event to allow the user to perform that event. For example, if the user performed a “double-tap” operation on a telephone icon associated with a past event, the controller 12 would initiate a voice communications program to allow the user to place a new call to the remote party associated with the past event (box 116). A new icon would then be placed, at the current time, on the first side of the timeline 42 to indicate that the call had been placed by the user (boxes 104, 106).

In one embodiment, the software program launched by application 30 provides its own user interface that covers or replaces all or part of GUI 40 on display 20. In another embodiment, however, the application 30 launches the software program within the GUI 40. In these embodiments, the software program that is launched may or may not be a “full” version having all functions and features, but instead, may be a “simplified” version of the software program having selected features and/or functions. Further, the user interface provided by the software program being launched may be opaque or transparent such that a user could interact with the user interface of the launched software program while still retaining the ability to view the components of the GUI 40.

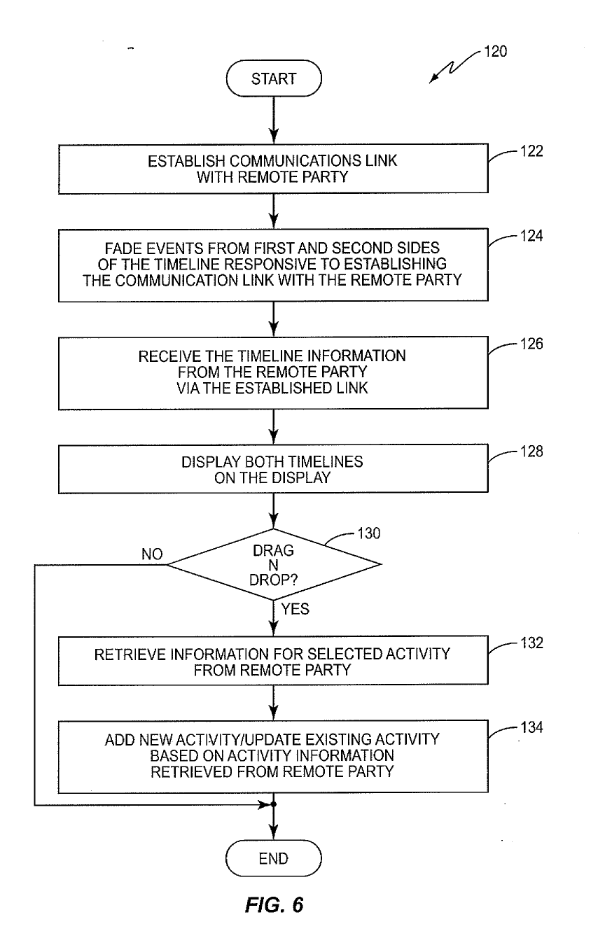

FIG. 6 is a flow diagram illustrating a method in which the user shares activities with other users by copying the activities to/from the other users' timelines in one embodiment of the present invention. Method 120 begins when the user's cellular telephone 10 establishes a communications link with the device of a remote party (box 122). As previously stated, either the user's device, or the remote party's device, may initiate establishing the link, which may be a cellular link or a short-range link. Upon establishing the link with the selected party, the controller 12 fades the event information on the first and second side of the timeline 12 and moves the timeline 12 towards one side of the display 20 (box 124). The user's device then receives the timeline information from the remote party's device via the established link (box 128). Authentication or other security procedures may be performed as is known in the art to help ensure privacy. The controller 12 will then, according to the logic and instructions of the application 30, display both the user's timeline and the remote party's timeline on display 20 (box 128).

While the timelines are displayed, the controller 12 will detect a drag and drop operation performed by the user to share the information for an activity (box 130). For example, as seen in FIG. 5, the user may drag-n-drop an activity from the remote party's timeline to his/her own timeline. Upon detecting the operation, the controller 12 will retrieve the information associated with the selected activity being dropped onto the user's timeline 42 (box 132), and add an activity (or update an existing activity) based on the retrieved information (box 134).

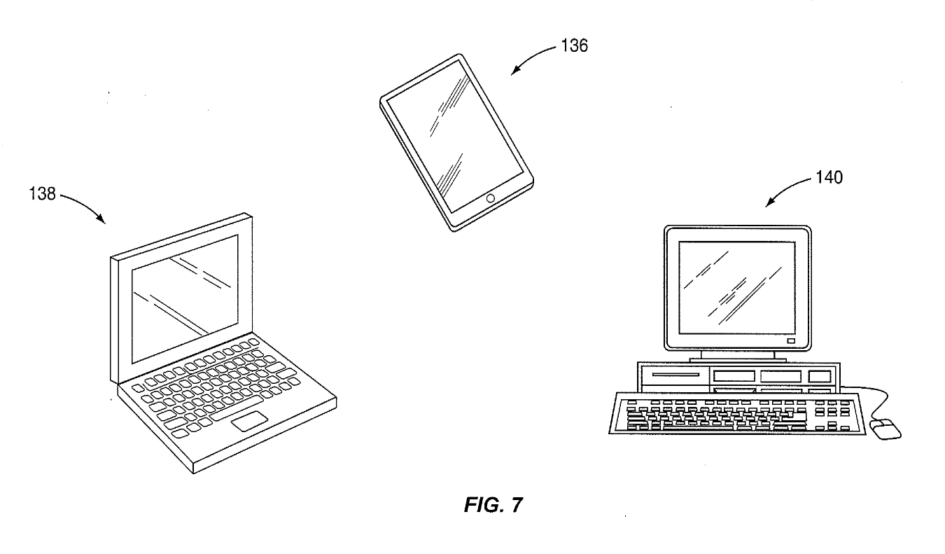

The present invention may, of course, be carried out in other ways than those specifically set forth herein without departing from essential characteristics of the invention. For example, as previously described, the timelines 42 extend longitudinally. In other embodiments, however, the timelines 42 extend horizontally. Further, in one embodiment, application 30 executes on a controller 12 of a cellular telephone 10. However, in other embodiments, application 30 executes on other electronic devices having a programmable processor and that capable of communicating with other, remote parties. FIG. 7, for example, Illustrates some examples of other suitable electronic devices. Particularly, the application 30 may be executed on a tablet computing device 136, such as APPLE′S iPAD. Generally, these tablet devices include touch-screen displays 20 and short-range transceivers 28 that enable them to communicate data and information with one or more remote parties via a wireless access point and the Internet.

Other examples of suitable devices are laptop computers 138 and desktop computers 140. These devices may not always include touch-screen displays 20, and thus, may not be able to perform the “double-tap” or “drag-n-drop” operations based on touch. Rather, such devices would rely on other pointing devices such as a mouse, a trackball, or a trackpad to perform these operations. Nevertheless, such computing devices 138, 140 still include a processor suitable for executing the application 30 as previously described, and also, are capable of communicating data and information to one or more remote parties via a short-range interface and the Internet.

Additionally, the previous embodiments describe the remote parties from which the user transmits/receives scheduling information (e.g., events) as being a person with a cellular telephone 10 or similar device. However, the present invention may also communicate such information with one or more servers associated with a social networking site. For example, social networks are rapidly becoming an important means of communication for many users. Typically, a user will connect to one or more friends or acquaintances via a social networking site, such as FACEBOOK and TWITTER. Messages originating from such sites and/or sent to such sites from cellular telephone 10 can be processed and displayed by application 30 in accordance with the present invention. This includes the ability to copy selected activities to and from a timeline associated with a social networking site as previously described.

Therefore, the present embodiments are to be considered in all respects as illustrative and not restrictive, and all changes coming within the meaning and equivalency range of the appended claims are intended to be embraced therein

What is claimed is:

1. A method for aggregating and displaying scheduling information on a communication device, the method comprising:
bisecting a display screen of a communication device using a timeline;
displaying events originated by a user of the communication device on a first side of the timeline;
displaying events associated with the user but originated by a remote party on a second side of the timeline opposite the first side;
displaying activities associated with the user along the timeline; and
displaying a current timeline indicator on the display screen to indicate which of the events and activities has already occurred, and which of the events and activities have yet to occur.

2. The method of claim 1 further comprising:
establishing a communication link between the user's communications device and a remote communications device associated with a remote user;
receiving a timeline associated with the remote party via the communication link; and
displaying the remote party's timeline on the display screen of the user's communications device.

3. The method of claim 2 further comprising:
subscribing to receive one or more timelines associated with each of one or more corresponding other parties;
indicating each of the timelines associated with one or more other parties on the display screen; and
selecting the remote party's timeline from among the plurality of timelines on the display screen.

4. The method of claim 2 further comprising adding one or more activities displayed along the remote party's timeline to the user's timeline responsive to the user dragging and dropping the one or more activities from the remote party's timeline onto the user's timeline.

5. The method of claim 2 further comprising adding one or more activities displayed along the user's timeline to the remote party's timeline responsive to the user dragging and dropping the one or more activities from the user's timeline onto the remote party's timeline.

6. The method of claim 2 further comprising controlling the display screen of the user's computer device to fade the events on the first and second sides of the timeline from the display screen responsive to receiving the remote party's timeline.

7. The method of claim 1 wherein displaying a current timeline indicator on the display screen comprises displaying the current timeline indicator to intersect the timeline at a current time.

8. The method of claim 1 further comprising adding a new event to the first side of the timeline responsive to the user selecting a past event, wherein the new event and the past event are of the same event type.

9. The method of claim 1 further comprising adding a new event to the second side of the timeline responsive to the remote party initiating the event.

10. The method of claim 1 further comprising adding a new activity along the user's timeline responsive to the user contacting the display screen along the timeline.

11. A communications device comprising:
a display;
memory configured to store scheduling information associated with the user; and
a controller configured to:
bisect the display using a timeline;
display events originated by a user of the communication device on a first side of the timeline;
display events associated with the user but originated by a remote party on a second side of the timeline opposite the first side;
display activities associated with the user along the timeline; and
display a current timeline indicator on the display to indicate which of the events and activities has already occurred, and which of the events and activities have yet to occur.

12. The device of claim 11 further comprising a communications interface configured to:
establish a communication link with a remote communications device associated with a remote user;
receive a timeline from the remote party via the communication link; and
display the remote party's timeline on the display of the user's communications device.

13. The device of claim 12 wherein the controller is further configured to:
subscribe to receive one or more timelines associated with each of one or more other parties;
indicate each of the timelines associated with one or more other parties on the display; and
select the remote party's timeline from among the plurality of timelines on the display responsive to user input.

14. The device of claim 12 wherein the controller is further configured to:
detect a drag and drop operation in which the user drags one or more selected activities from the remote party's timeline and drops the one or more selected activities along the user's timeline; and
add the one or more selected activities to the user's timeline responsive to the drag and drop operation.

15. The device of claim 12 wherein the controller is further configured to:
detect a drag and drop operation in which the user drags one or more selected activities from the user's timeline and drops the one or more selected activities along the remote party's timeline; and
add the one or more selected activities to the remote party's timeline responsive to the drag and drop operation.

16. The device of claim 12 wherein the controller is further configured to fade the events on the first and second sides of the timeline from the display responsive to receiving the remote party's timeline.

17. The device of claim 11 wherein the controller is further configured to display the current timeline indicator to intersect the timeline at a current time.

18. The device of claim 11 wherein the controller is further configured to add a new event to the first side of the timeline responsive to the user selecting a past event, wherein the new event and the past event are of the same event type.

19. The device of claim 11 wherein the controller is further configured to add a new event to the second side of the timeline responsive to the remote party initiating the event.

20. The device of claim 11 wherein the controller is further configured to add a new activity along the user's timeline responsive to the user contacting the display screen along the timeline.
